(19) United States
(12) Patent Application Publication
(10) Pub. No.: US 2011/0228344 A1
(43) Pub. Date: Sep. 22, 2011

(54) IMAGE PROCESSING METHOD, IMAGE PROCESSING APPARATUS, AND IMAGE PROCESSING PROGRAM

(75) Inventor: Yasushi Takeo, Matsumoto-shi (JP)

(73) Assignee: SEIKO EPSON CORPORATION, Shinjuku-ku (JP)

(21) Appl. No.: 13/051,988

(22) Filed: Mar. 18, 2011

(30) Foreign Application Priority Data
Mar. 19, 2010 (JP) 2010-065009

(51) Int. Cl. G06T 5/00; G06K 15/02

(52) U.S. Cl. 358/3.27

(57) ABSTRACT

An image processing method to cause a computer executing includes reading ideal image data including correction history information of a parameter for original image data and acquiring an ideal correction parameter, calculating an initial ink use amount when printing the ideal image data, calculating a relation between each correction value of the ideal correction parameter and the ink use amount on the basis of the initial ink use amount, calculating a proper correction value approximating a target ink use amount input by a user in the relation between each correction value of the ideal correction parameter and the ink use amount, and creating correction image data in which the ideal correction parameter of the ideal image data is set by the proper correction value and displaying the correction image data on a display.

Priority is claimed under 35 U.S.C. §119 to Japanese Application No. 2010-065009 filed on Mar. 19, 2010, which is hereby incorporated by reference in its entirety.

### BACKGROUND

1. Technical Field

The present invention relates to an image processing method when printing an image, and more particularly, to an image processing method for suppressing deterioration of image quality when reducing the ink use amount of an image printed by, for example, an ink jet printer.

2. Related Art

An ink jet printer performing printing by discontinuously ejecting ink on various mediums such as paper, cloth, and film has been known as a printing apparatus. The ink jet printer arranges fine dots formed of ink droplets onto the medium to form an image. Such an ink jet printer is provided with a plurality of ink cartridges filled with ink of a plurality of colors and can perform printing with various colors. When replenishing ink, only the cartridge may be replaced. Accordingly, the ink jet printer is used to print, for example, a face of discount tickets (coupons) of products distributed on counters of stores.

Recently, the ink jet printer is used for immediate color printing of various kinds of coupons for purchased products, cooperating with to the known POS system in the store. For example, when a barcode of a specific product is read on the counter of the store, product information is transmitted to a definite-purpose printer through the POS system. The printer has stored in advance a correspondence between the product information transmitted from the POS system and a coupon to be printed, and the immediately prints and issues a predetermined coupon on the basis of the information transmitted from the POS system.

However, as a business model formed by the issuing service of the coupon, for example, in a case where a company B later produces and sells products similar to products produced by a company A, the company B issues an available coupon when a customer purchases the product of the company B for social publicity and sales promotion of the company B. The company B pays the expenses of the discount. When the customer purchases the product of the company A in the store, the coupon is issued. Accordingly, the company B can obtain the publicity for the fact that a similar product from a company other than the company A is provided, and through the money discounted by the coupon can motivate the customer to purchase the product of the company B.

In the business model, an advertisement agency relays between the store and the company B, a production and sales company of the issuing system of coupons, a maker selling a printer and the other hardware constituting the issuing system and supplies obtain profits.

For example, in the above-described business model, there are many cases where expenses for the supplies used in the printer are paid to the printer producing company according to the amount thereof used. Particularly, there are many cases where the expenses for ink are paid according to the use amount thereof. That is, for the ink jet printer, the expenses are not paid for the replacing ink cartridge, and the use amount is calculated by the number of ejections of ink to pay the expense according to the use amount. For this reason, no matter who pays the expenses for the ink, there is a desire to reduce the ink use amount as far as possible. A technique of managing the ink use amount is disclosed in JP-A-2007-118490.

However, a face of the coupon issued in the above-described business model needs to function as an advertisement for the product from the viewpoint of product publicity. For this reason, the company B or the like as the actual issuing source of the coupon has a desire to arouse a customer's interest by printing an image, on which a clever image designed by an image creator such as a professional designer is concentrated, on the face. Accordingly, when reducing the ink use amount at random, it is difficult to print with quality a printed matter in which customers are interested. As a result, the effectiveness of the advertisement is decreased, the proper effect of issuing the coupons disappears, and the business model may be not satisfied. Of course, it is not limited to the exemplified business model, and there is a great demand to reduce the ink use amount while minimizing the deterioration of image quality.

### SUMMARY

An advantage of some aspects of the invention is to provide an image processing method, an image processing apparatus, and an image processing program supporting a creator of an image to suppress deterioration of image quality to the minimum while reducing the ink use amount when the image printed by a printer is created. Another advantage will be clearly described below.

According to an aspect of the invention, there is provided an image processing method when creating an image which a computer causes a printing apparatus forming an image to print using ink, the method including: reading ideal image data including correction history information of a parameter for original image data and acquiring the parameter included in the correction history information as an ideal correction parameter; calculating an ink use amount as an initial ink use amount when printing the ideal image data; calculating a relation between each correction value of the ideal correction parameter and the ink use amount on the basis of the initial ink use amount; calculating a proper correction value approximating a target ink use amount input by a user in the relation between each correction value of the ideal correction parameter and the ink use amount; and creating correction image data in which the ideal correction parameter of the ideal image data is set by the proper correction value and displaying the correction image data on a display. Another aspect of the invention will be clarified by the specification and the accompanying drawings.

### BRIEF DESCRIPTION OF THE DRAWINGS

The invention will be described with reference to the accompanying drawings, wherein like numbers reference like elements.

FIG. 1A, FIG. 1B, and FIG. 1C are diagrams illustrating a black level correction value.

FIG. 2A and FIG. 2B are diagrams illustrating relation between the black level correction value and the ink use amount.

FIG. 3 is a flowchart illustrating an information process in a first embodiment of the invention.

FIG. 4 is a diagram illustrating an example of an operation screen displayed on a computer in the course of the information process in the first embodiment.

FIG. 5 is a diagram illustrating an example of a display state of the operation screen.

FIG. 6 is a diagram illustrating an example when the display state of the operation screen is changed.

FIG. 7 is a diagram illustrating another example when the display state of the operation screen is changed.

FIG. 8A and FIG. 8B are diagrams illustrating a structure of ideal image data in a second embodiment of the invention.

FIG. 9A and FIG. 9B are diagrams illustrating the other structure of the ideal image data in the second embodiment.

FIG. 10A, FIG. 10B, and FIG. 10C are schematic diagrams illustrating an image processing method according to a third embodiment of the invention.

FIG. 11A and FIG. 11B are schematic diagrams illustrating an example of a tone curve correction method.

### DESCRIPTION OF EXEMPLARY EMBODIMENTS

In the embodiment of the invention, for example, in the use of printing an image on the face of the coupon, it is assumed that an image creator creates an image (hereinafter, referred to as an ideal image) considered as ideal using image creating software installed on a computer, and it is necessary to reduce the ink use amount since the ink use amount is large to print the ideal image. In the assumption, the embodiment of the invention is an image processing method for supporting a work of creating an image finally provided for printing for the image creator by using a computer, considering the ink use amount and deterioration of image quality.

The image created using the computer is a bitmap image data in which tone values of three primary colors RGB are assigned for pixels. The ink use amount necessary to print the image can be acquired through information processes of performing a color conversion process of converting the bitmap image data into a color system (e.g., CMY color system) in the printer and a halftone process of representing gradation by the number of dots per pixel and performing a dot counting process of calculating the number of actually ejected ink droplets (ink use amount) thereon.

In a comparative example of the invention, using software calculating the ink use amount necessary to print the image by the information processes, the image creator first checks the ink use amount necessary to print the image for the ideal image. When the ink use amount is large, the image is corrected to reduce the ink use amount, for example, by increasing a white part where no ink is used or making a color tone dilute, and the ink use amount is checked again. Such a work is repeated to gradually reduce the ink use amount. A complex work taking a very long time, when an image finally provided for printing is created considering balance of a target ink use amount and deterioration of image quality, is necessary.

Thus, for the ideal image, paying attention to an increase or decrease of the ink use amount by correcting various parameters (black level, gamma characteristics, contrast, tone curve, etc.), reducing the ink use amount by variably setting such parameters was considered. However, the ideal image is adjusted to an image quality considered as ideal by the image creator by correcting various parameters at the step of creating the image. Accordingly, even when the ink use amount is reduced by correcting arbitrarily selected parameters, the image after the correction may be an image out of the image intended by the image creator. That is, the “image style” is changed.

The embodiment of the invention is an image processing method for making the ink use amount as close to a target usage amount as possible while keeping the image style of the ideal image. The embodiment of the invention may have the following characteristics in addition to the embodiment corresponding to the characteristics of the main invention.

The correction value of the ideal correction parameter is included as an ideal correction value in the correction history information; in the acquisition of the correction history, the ideal correction value included in the correction history is acquired and a direction of increase or decrease of the ideal correction parameter for the original image data is determined as an ideal direction; and in the calculation of the proper correction value, the absolute value of the proper correction value is equal to or less than the absolute value of the ideal correction value when the increase or decrease direction of the absolute value of reducing the ink use amount of the ideal image data is reverse to the ideal direction.

The ideal image data is formed of a plurality of layer images including each correction history; in the acquisition of the correction history, the correction history included in each layer is acquired; in the calculation of the ink use amount, a relation between each correction value of the ideal correction parameter for each layer and the ink use amount is calculated; and in the calculation of the proper correction value, the proper correction value of each layer is calculated such that the reduced amount of ink of the layers are equal.

The ideal image data is formed of a plurality of layer images including each correction history; in the acquisition of the correction history, the correction history included in each layer is acquired; in the calculation of the ink use amount, a relation between each correction value of the ideal correction parameter for each layer and the ink use amount is calculated; and in the calculation of the proper correction value, the proper correction value of each layer is calculated such that an ink reduction amount of the layer designated by an input of the user reaches the maximum.

The correction history includes an ideal correction value for each of a plurality of ideal correction parameters; in the calculation of the ink use amount, a relation between each correction value for each of the plurality of ideal correction parameters and the ink use amount is calculated; and in the calculation of the proper correction value, the proper correction value for each ideal correction parameter is calculated such that the ink reduction amounts of the ideal correction parameters are equal.

In the correction history, an ideal correction value for each of a plurality of ideal correction parameters is described; in the calculation of the ink use amount, a relation between each correction value for each of the plurality of ideal correction parameters and the ink use amount is calculated; and in the calculation of the proper correction value, the proper correction value for each ideal correction parameter is calculated such that the ink reduction amount reaches the maximum in order from a high-priority ideal correction parameter according to correction priority set for each parameter.

The invention includes an image processing apparatus, the image processing apparatus according to the embodiment of the invention is an image processing apparatus creating an image printed by a printing apparatus forming an image using ink, and includes:

a correction history acquiring unit reading ideal image data including correction history information of a parameter for original image data and acquiring the parameter included in the correction history information as an ideal correction parameter;

an ideal image ink use amount calculating unit calculating an ink use amount as an initial ink use amount when printing the ideal image data;

an ink use amount calculating unit calculating a relation between each correction value of the ideal correction parameter and the ink use amount on the basis of the initial ink use amount;

a proper correction value calculating unit calculating a proper correction value approximating a target ink use amount input by a user in the relation between the correction value of the ideal correction parameter and the ink use amount; and

a correction image displaying unit creating correction image data in which the ideal correction parameter of the ideal image data is set by the proper correction value and displaying the correction image data on a display.

In addition, an image processing program is included in the scope of the invention, the image processing program according to the embodiment of the invention is installed on a computer and is a program for causing the computer to create an image printed by a printing apparatus forming an image using ink, and causes the computer to execute:

reading ideal image data including correction history information of a parameter for original image data and acquiring the parameter included in the correction history information as an ideal correction parameter;

calculating an ink use amount as an initial ink use amount when printing the ideal image data;

calculating a relation between each correction value of the ideal correction parameter and the ink use amount on the basis of the initial ink use amount;

calculating a proper correction value approximating a target ink use amount input by a user in the relation between the correction value of the ideal correction parameter and the ink use amount; and

creating correction image data in which the ideal correction parameter of the ideal image data is set by the proper correction value and displaying the correction image data on a display.

For example, image data of an image photographed by a digital camera includes data and time of photographing, and settings (aperture value, shutter speed, zoom magnification, ISO sensitivity, etc.) of the camera during photographing. In the known Exif type, the contents (kinds of parameters and correction values) of correction image-processed by the digital camera are included as history. When the photographed image is subjected to correction in various parameters on a computer using image processing software called photo retouching software, the correction history thereof is included.

The image creator who designs the face of the coupon creates an ideal image while correcting the proper parameters with respect to a material image (hereinafter, referred to as an original image). Accordingly, in order to reduce the ink use amount when printing the ideal image, the proper parameters of the ideal image are further corrected to reduce the ink use amount. However, as described above, it is necessary to cautiously select the parameters of the correction.

The parameters corrected by the image creator in the course of creating the ideal image are the intention of the image creator. When the intention is respected, it is thought that the image style is not greatly damaged. Data (ideal image data) of the ideal image includes data concerning the correction history (original image data) of the original image, and thus it is preferable that the ink use amount is not reduced by daring to correct parameters which are not in the history.

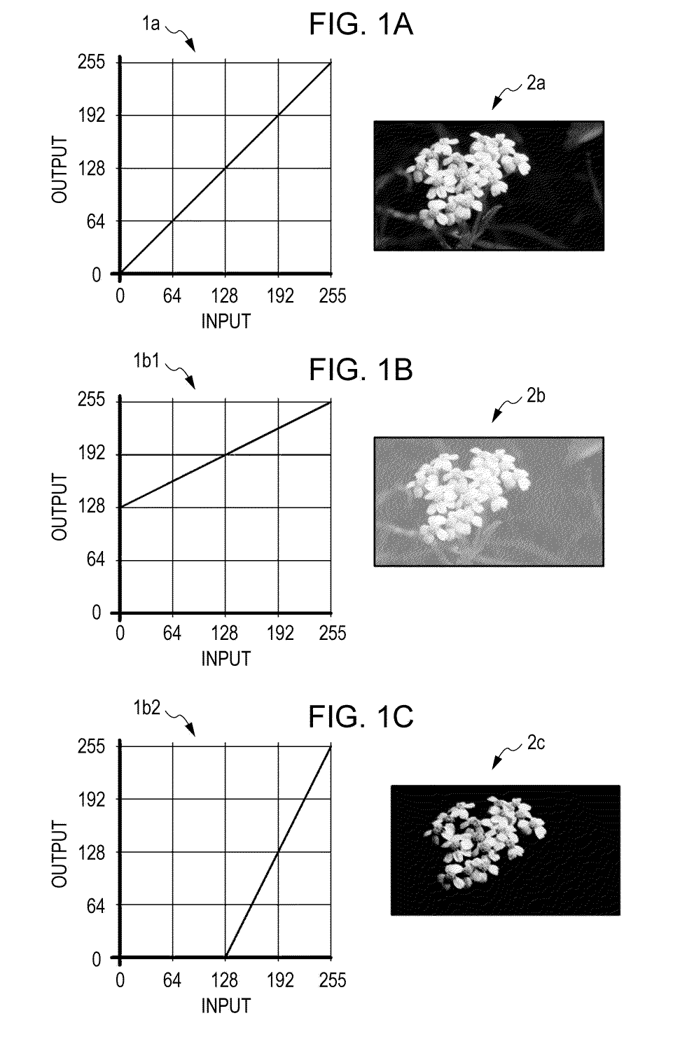

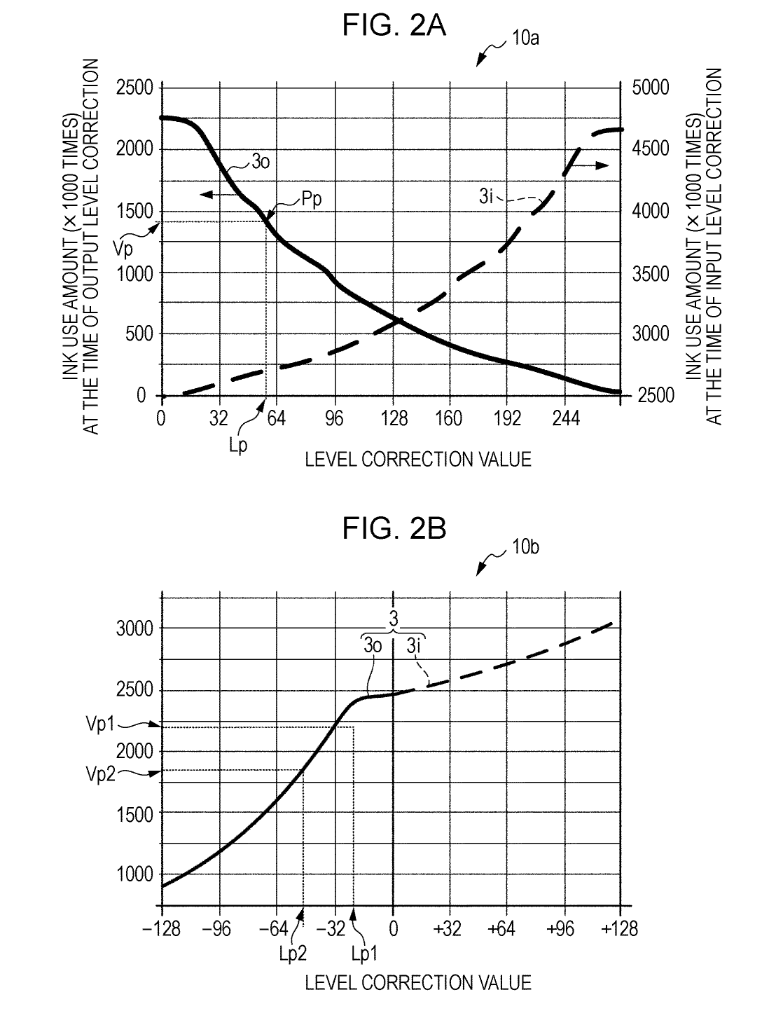

The principle of the image processing method according to the embodiment of the invention will be described with reference to a specific example. Herein, for example, it is assumed that the image creator corrects the black level of the original image in the course of creating the ideal image, the correction values of the black level are intentionally set by the image creator to reduce the ink use amount of the ideal image is corrected. FIG. 1A, FIG. 1B, and FIG. 1C show a concept of correction of the black level. FIG. 1a is before correction, and FIG. 2B and FIG. 2C are after correction. For example, when a level is represented by 8 bits (256 black level), as shown in the left graphs (1a, 1b, and 1c) of FIG. 1A to FIG. 1C, the 256 level is assigned to an input image and an output image. Generally, in the case of “black level correction”, for the input image with a gradation represented by a level of 0 to 255, the gradient of the output image is variable from a value between a level of 0 to 255 and a level of 255.

FIG. 1A is a case where the black level correction is not corrected, and the gradient of the input and the output is represented by the same level 256. That is, a variable setting value (hereinafter, referred to as an output level correction value) of the black level of the output is 0, which is an ideal image state. Accordingly, the gradation is represented by the output level from 0 to 255 of the most dilute (white state). On the right, the image (ideal image) 2a before correction is shown.

When the output level of the ideal image 2a is changed to set the level correction value of the output as shown in Graph 1b1 of FIG. 1B, the gradation is represented from an initial level of 128 to a level of 255. That is, the darkest level is a gradient of the initial 128 level. Accordingly, the image 2b after correction is an overall dilute image as compared with the ideal image 2a. To print the image 2b after correction, ink necessary to represent the gradient of level 0 to 127 is not necessary, and it is possible to surely reduce the ink use amount.

When the input level of the ideal image 2a is changed to set the input level correction value to 128 as shown in Graph 1b2 of FIG. 1C, the output level is represented from 0 level to 255 level. However, when the input level reaches level 128, the output level becomes level 0, and the image 2c after correction of a halftone part to level 128 in the ideal image 2a becomes an image punctured to black. Accordingly, the ink use amount increases.

FIG. 2A shows a relation between the level correction value and the ink use amount when performing the black level correction on any ideal image 2a by Graph 10a. The horizontal axis of Graph 10a is the level correction value of input or output. The vertical axis on the left is the ink use amount for the level correction value of output, and the vertical axis on the right is the ink use amount for the level correction value of input. The ink use amount is regulated by the number of ejections of ink. The two curves (3o and 3i) of Graph 10a are a curve (hereinafter, referred to as an output ink use amount curve) 3o representing relation between the output level correction value and the ink use amount and a curve (hereinafter, referred to as an input ink use amount curve) 3i representing relation between the input level correction value and the ink use amount.

Herein, two image processing methods are considered according to the purpose of reducing the ink use amount. In the first image processing method, the highest priority is to achieve a target ink use amount Vp. In this method, for example, the image creator corrects the black level of the original image in the course of creating the ideal image, the black level is corrected to achieve the target ink use amount Vp irrespective of the input or the output of the correction target of the black level. Specifically, when the parameter of correction included as the correction history in the ideal image data is the black level, the target ink use amount Vp is associated with the output ink use amount curve 3o in Graph 10a shown in FIG. 2A. A level correction value Lp corresponding to an intersection point Pp between the target ink use amount Vp and the output ink use amount curve 3o is employed as a proper correction value.

The highest priority of the second image processing method is to approach to the target ink use amount as possible, and to give greater priority to the image quality intended by the image creator without correction than to the offsetting correction performed in the course of creating the ideal image by the image creator. For example, when the correction history of the ideal image data includes the correction of the output level of the black level correction value, the image creator is performing correction in a direction to brighten the original image as a source of the ideal image. Accordingly, as described above, the level correction value Lp corresponding to the intersection point Pp between the target ink use amount Vp and the output ink use amount curve 30 may be employed as the proper correction value.

However, when the image creator corrects the input level and the black level is corrected by the proper correction value Lp, it may be contrary to the intention of the image creator to make the original image dark. For example, when the input level is set to level 32 for the original image to create the ideal image, the proper correction value of the output level is over level 32. That is, the ink use amount achieves the target ink use amount by brightening, exceeding the intention of the image creator. Accordingly, in this case, resetting the correction value of the black included in the ideal image data to return to the original state should be not performed.

A concept of the second image processing method is shown in Graph 10b of FIG. 2B. A curve 3 shown in Graph 10b represents an ink use amount when correcting the black level for the ideal image, and the level correction value 0 is an ideal image state. In Graph 10b, when the input level of the black level is corrected, a plus sign is given to the correction value for the level correction value of the horizontal axis, and a minus sign is given to the correction value for the output level. Accordingly, a part corresponding to the plus side of the horizontal axis of the curve 3 is an input ink use amount curve 3i shown in FIG. 2A, and the minus side corresponds to an output ink use amount curve 3o.

It is assumed that it is included that the black level (hereinafter, referred to as Li) is corrected to +32 corrected for the original image data as the correction history included in the ideal image data. That is, it is assumed that Li=+32 representing the black level increasing by level 32 is included. In this state, when the target ink use amount Vp1 shown in FIG. 2B is designated, the correction value LP1 corresponding to an intersection point P1 between the usage amount Vp1 and the ink use amount curve 3 is −32<LP1<0 and is corrected toward the minus side opposite to the plus correction direction from the original image. When absolute values of both are compared, |Li|>|LP1|, and thus it is not brighter than the original image. Accordingly, in this case, LP1 may be employed as the proper correction value.

However, when the target ink use amount Vp2 shown in FIG. 2B is designated, a correction value LP2 corresponding to an intersection point P1 between the use amount Vp2 and the ink use amount curve 3 is LP2<−32 and is corrected toward the −side opposite to the plus correction direction from the original image. When absolute values of both are compared, |Lf|<|LP2|, and thus it is brighter than the original image, which is contrary to the intention of the image creator. In such a case, the proper correction value Lp is −32. That is, −32 is a limit value of correction.

Even when the image creator corrects a parameter other than the black level in the course of creating the ideal image, it is preferable that the horizontal axis of Graphs 10a and 10b shown in FIG. 2A and FIG. 2B is replaced by the correction value of the parameter and the ink use amount calculates the ink use amount of the parameter for each correction value. In addition, it is preferable that a limit value is set on the proper correction value according to a direction of increase or decrease of correction, and the correction is performed so as not to exceed the limit value.

### First Embodiment

An embodiment of the invention is realized by executing a program installed on a computer. The program (hereinafter, referred to as image processing software) causes the computer to perform a process of calculating an ink use amount from a bitmap data of an image to be printed, a process of specifying a correction value for each parameter included in the image data, a process of correcting various parameters of the image data, a process of displaying the image before and after correction, and a process of calculating a proper correction value according to a target ink use amount.

Herein, the image creator corrects a black level for an original image data to create an ideal image data, a work sequence until the ideal image data is processed by a computer (hereinafter, an image processing apparatus) executing the image processing software to convert it into an image (correction image) for printing with the ink use amount approaching the target ink use amount is exemplified, and a user interface circumference or an information process in the image processing apparatus in the work is the first embodiment of the invention.

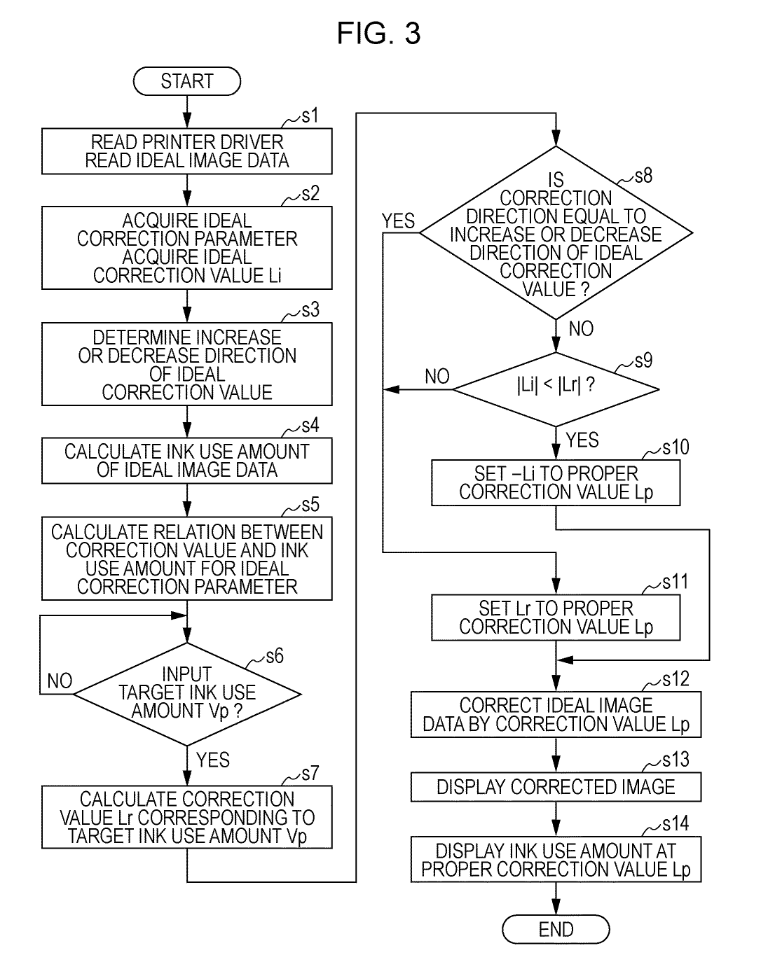

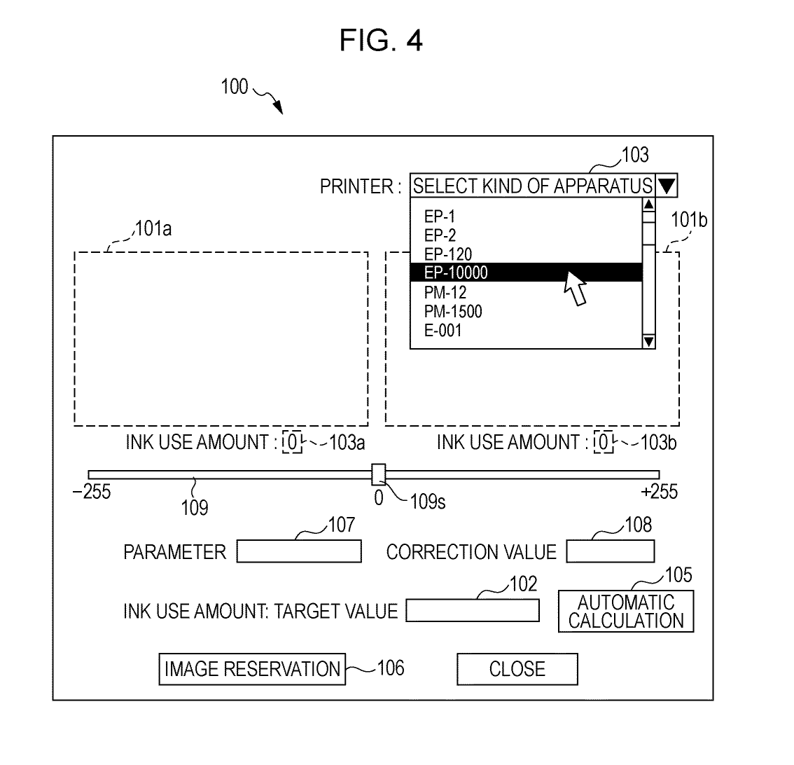

FIG. 3 shows flow of the information process performed by the computer. FIG. 4 to FIG. 7 show schematic diagrams of a screen displayed on a display of the computer in the course of the information process. Printer drivers corresponding to various kinds of printers are included as a module, and a function of correcting various parameters for the ideal image data to create an image after the correction is provided as in a program for general image processing called photo retouching software.

When the computer operates the supportive software by an operation input of a user who is the image creator, a work screen 100 of the support software is displayed on a display as shown in FIG. 4. The work screen 100 includes areas 101a and 101b for displaying the images before and after correction, an input section 102 for the target ink use amount, a list down box 103 for selecting a printer model, various buttons 105 and 106 for calculating a proper correction value or storing the image data after correction, and the like. In addition, the work screen includes a display section 107 of a parameter that is the correction target, a display section 108 of a correction value thereof, and a slide bar 109 for recognizing the ink use amount by a slider 109s moving left and right.

When the user selects a printer and designates the file of the ideal image data, the corresponding printer driver and the real image data are read, and an ideal correction parameter and an ideal correction value Li that are the contents of the correction history included in the ideal image data are acquired (s1 and s2). In addition, the direction of increase or decrease of the ideal correction value is determined (s3). The ink use amount when printing the ideal image data using the designated printer is calculated, and correspondence between the correction value of the ideal correction parameter and the ink use amount is calculated (s4 and s5).

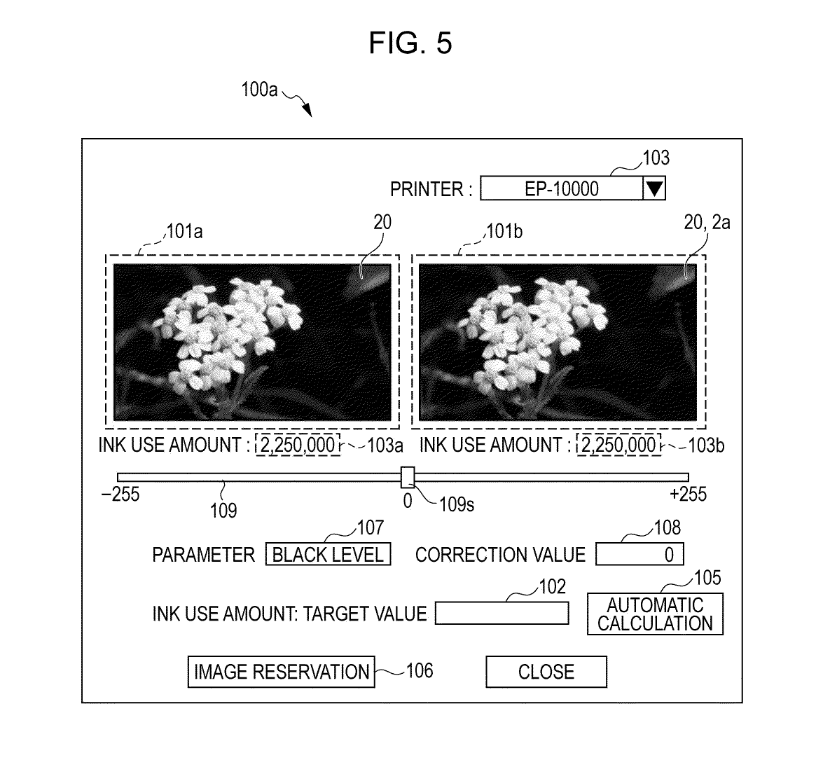

When the image processing apparatus reads the ideal image data, as shown in FIG. 5, the image processing apparatus arranges the ideal image 2a before correction and the correction image 20 after correction on the left and right in the image display areas 101a and 101b before and after correction of the work screen 100a. The ink use amount necessary to printing the ideal image 2a and the correction image 2b and the level correction value are displayed in the display areas 103a, 103b, and 104. Herein, since the target ink use amount is not designated, the correction image 20 is substantially the same as the ideal image 2a before correction and the ink use amount is naturally the same. For the ink use amount, the number of ink ejection times of the ink jet printer is displayed. The ideal correction parameter included in the correction history and the kind thereof are automatically input to the display section 107. “0” representing that no correction is performed is automatically input to the display section 108 of the correction value, and the slider 109s of the slide bar 109 is positioned at the center.

Then, the user inputs the target ink use amount Vp to the input section 102 on the work screen 100a to appoint an automatic calculation button 105, the image processing apparatus substitutes the target ink use amount Vp for the above-calculated relation between the correction value and the ink use amount, and calculates an approximate level correction value (approximate correction value) Lr (s6→s7). Herein, the increase or decrease direction of the approximate correction value Lr is compared with the increase or decrease direction of the ideal correction parameter, and when they have the same direction, the approximate correction value Lr is employed as a proper correction value Lp (s8→s11).

When the increase or decrease directions do not coincide with each other, the absolute value of the ideal correction value Li of the ideal correction parameter is compared with the absolute value Lr of the approximate correction value. In a case of |Li|<|Lr|, a proper correction value Lp=−Li to offset the correction value Li at the time of conversion from the original image data into the ideal image data, without needing to reach the target ink use amount (s8→S9→S10). Even when the increase or decrease directions does not coincide with each other and |Li|≧|Lr|, Lp=Lr is set (s8→S9→S11).

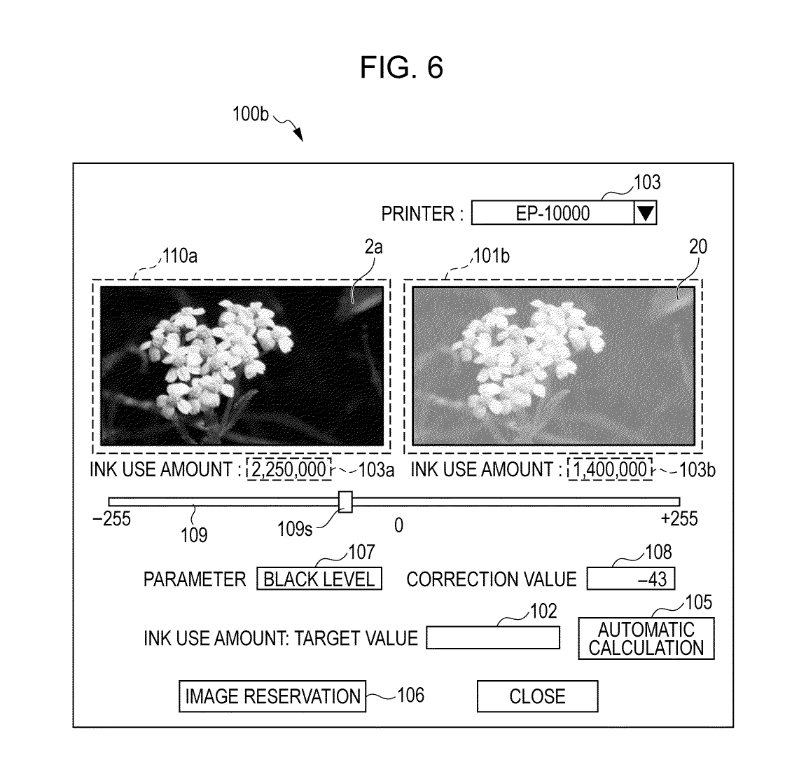

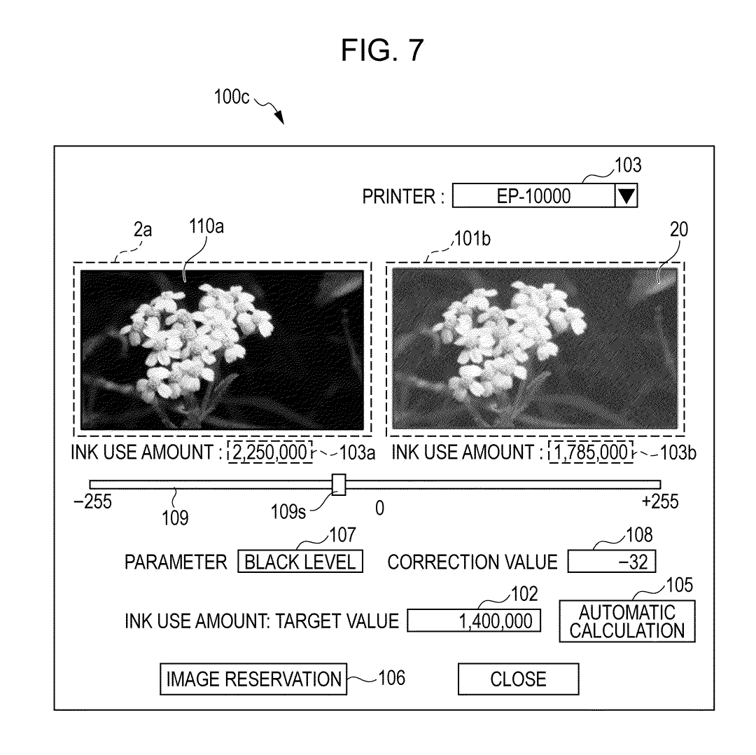

As described above, when the proper correction value Lp is set, the ideal image data is corrected such that the ideal correction parameter of the ideal image data is Lp (s12), and the correction image 20 is displayed in the display area 101b of the correction image on the work screen 100a of the image processing software as shown in FIG. 6 on the basis of the correction image data after the correction. The ink use amount in the proper correction value Lp is displayed in a predetermined area 103b of the operation screen 100 (s13 and s14). The specific proper correction value Lp is also displayed at the display position 108, and the slide bar 107 is moved to a position corresponding to the level correction value Lp. FIG. 6 and FIG. 7 show a work screen 100b when setting Lp=Lr and a work screen 100c when setting Lp=−Li.

### Second Embodiment

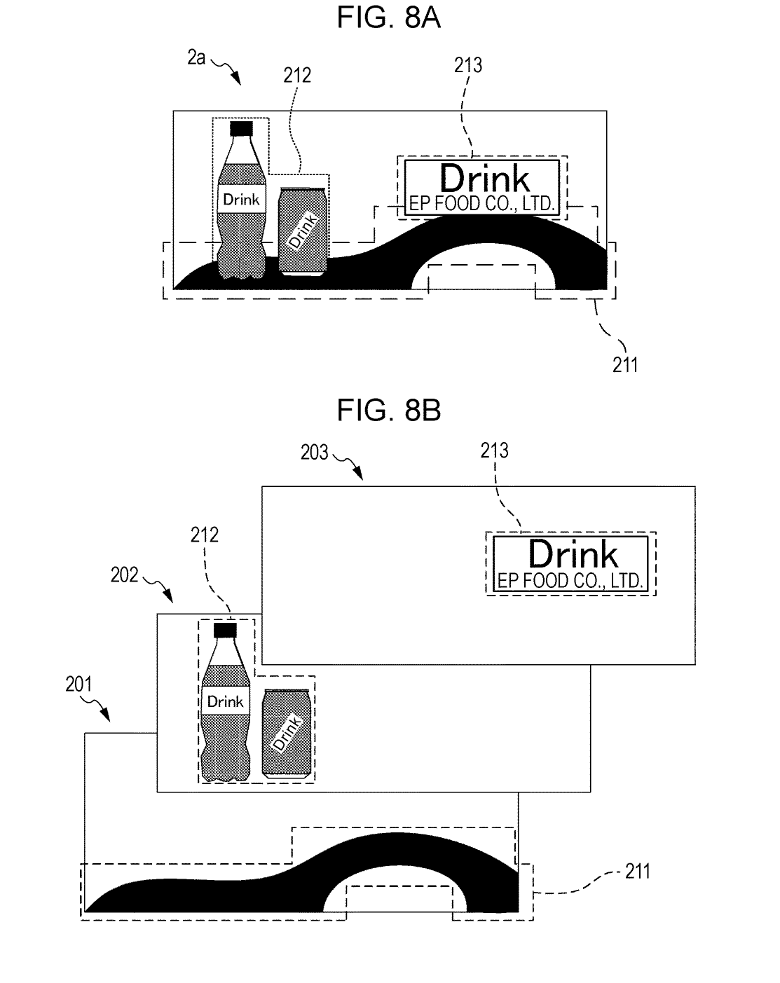

As software creating the ideal image data from the original image data, there is software managing an image in a layer structure called the known layer. For example, in an image on the face of the coupon, data of the ideal image 2a shown in FIG. 8A is arranged sequentially upward from a layer 201 of a background image 211 as the lowest layer toward the upper layer data as shown in FIG. 8B, to have a structure of piling a layer 202 of an image 212 of a product picture and a layer 203 of an image 213 of a product name (logo). The layers 201 to 203 are drawn by correcting individual original images. Accordingly, the ideal correction parameter corresponds to the ideal correction value for each of the layers 201 to 203. As the second embodiment of the invention, an information process when processing the ideal image data having such a layer structure to reduce the ink use amount is exemplified. Hereinafter, the lowest layer is the first layer, and upward layers are called the second layer and the third layer.

Herein, the ideal image 2a is created by correcting the black level of the original image corresponding to each of the layers 201 and 203 by the ideal correction value, and the image processing method according to the second embodiment will be described. Also, in the second embodiment, the image processing method is based on the above-described “Image Processing Principles”.

In the image processing method of the second embodiment, first, it is considered that the correction is performed to reduce the ink use amount of image data, considering the ideal image 2a as the image data formed of one layer. In this case, the correction is performed by the same image processing method as the first embodiment. When there is a difference in the level correction value from the original image in the layers 201 to 203 and the increase or decrease directions of the level correction values are plus and minus in mixed, it is preferable to perform the image process by providing a proper standard, such that the ideal correction value with the largest absolute value among the ideal correction value of plus included in the layers 201 to 203 is acquired so as not to perform the correction of level exceeding the ideal correction value.

Meanwhile, it is conceivable that the layers are individually corrected. In such a case, it is preferable to perform the same image process as the first embodiment for the layers 201 to 203. For example, it is conceivable to correct the ideal correction parameters of the layers such that the ink reduction amounts in the layers are equal.

When any layer is the other plus by the ideal correction value of the minus direction and only the layer of minus is corrected by a large correction value, a balance of the black level with the other layer is broken, In this case, the image style of the ideal image may be damaged, the correction value is corrected one at a time in the minus direction of reducing ink. When the ideal correction value of the layer including the ideal correction value of plus cannot be corrected more than that, it is preferable to correct the layer of minus. In addition, when there is a layer which does not include the correction history, that is, the layer in the original image state, the layer may not be corrected. Moreover, there is a demand to maintain the ideal image quality in the logo or the product image of the coupon, considering an advertising effectiveness. In such a case, the user may designate a layer of a correction target.

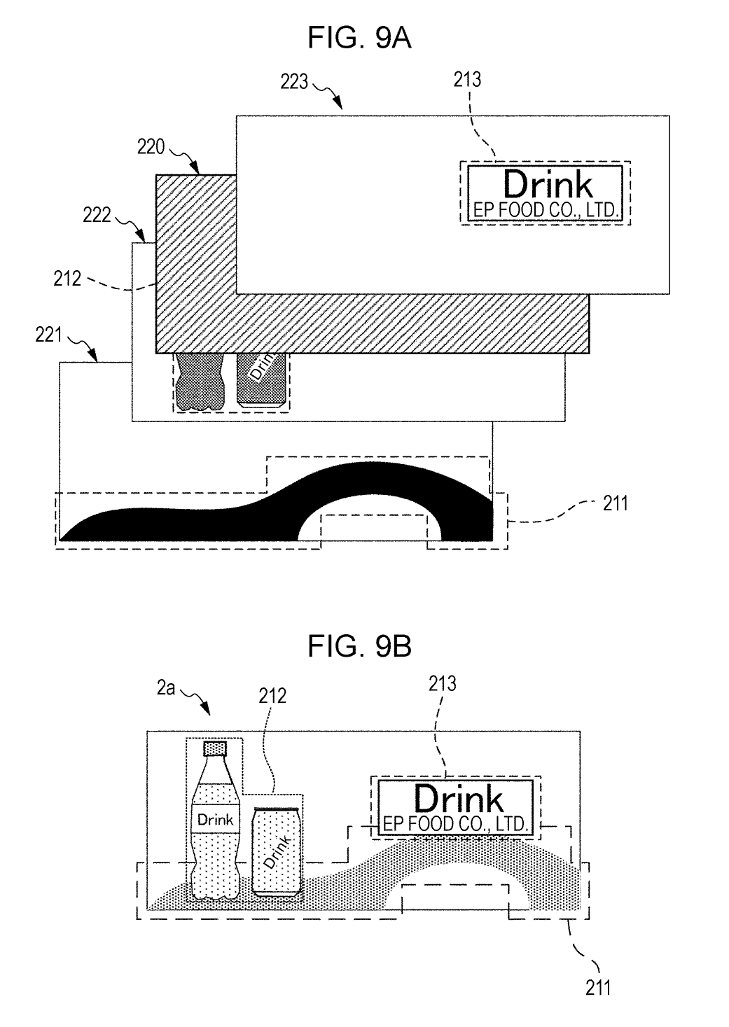

However, there are a case where the image data having the layer structure includes the correction history for each layer, and a case where the correction history is included as information different from the original image called a parameter layer. FIG. 9A and FIG. 9B show a concept of the parameter layer. In this example, as shown in FIG. 9A, the parameter layer 220 is interposed between the second layer 222 of the original image and the third layer 223 of the original image. In this example, the correction history of correcting the output level of the black level is included. In the ideal image 2a, as shown in FIG. 9B, the correction history included in the parameter layer is applied only to the first layer 221 and the second layer 222, and the third layer 223 is in the original data state. Also in this case, it is preferable to reduce the ink use amount by correcting the ideal correction parameter included in the parameter layer 220 in the final ideal image, considering the final ideal image as the first-layer image. Alternatively, when the layer structure is kept and the ideal correction parameter included in the parameter layer 220 is further corrected, only the first layer 221 and the second layer 222 are corrected.

### Third Embodiment

In the embodiment, the parameter that is the correction target is only one kind, but a case where a plurality of parameters in the original image are corrected to create an ideal image is also assumed. In the third embodiment, an image processing method of correcting the plurality of parameters is provided. Also in the third embodiment, the image processing method is based on the “Principle of Image Processing Method”. However, influence due to the correction are various according to the parameter, among the various parameters, a parameter greatly contributing to the reduction of ink due to small corrections, on the contrary, a parameter with a small ink reduction amount even with large corrections, or a parameter which does not damage the image style even with large corrections, and parameter of greatly damaging the image style due to small corrections. Also herein, there are several methods according to priority (ink use amount priority, or image quality priority) of reducing ink.

As a method of correction, first, it is conceivable to uniformly correct all the plurality of parameters. For example, when the black level and gamma characteristics in the original image are corrected to create the ideal image, the ink use amount is calculated for an organization of the correction value of the black level and the correction value of the gamma value, and a table including relation between the organization of the black level and the correction value of the gamma value and the ink use amount is created. Also herein, in case of giving priority to image quality, it is preferable to determine the increase or decrease direction of the correction value and to provide a correction limit for the black level and the gamma value.

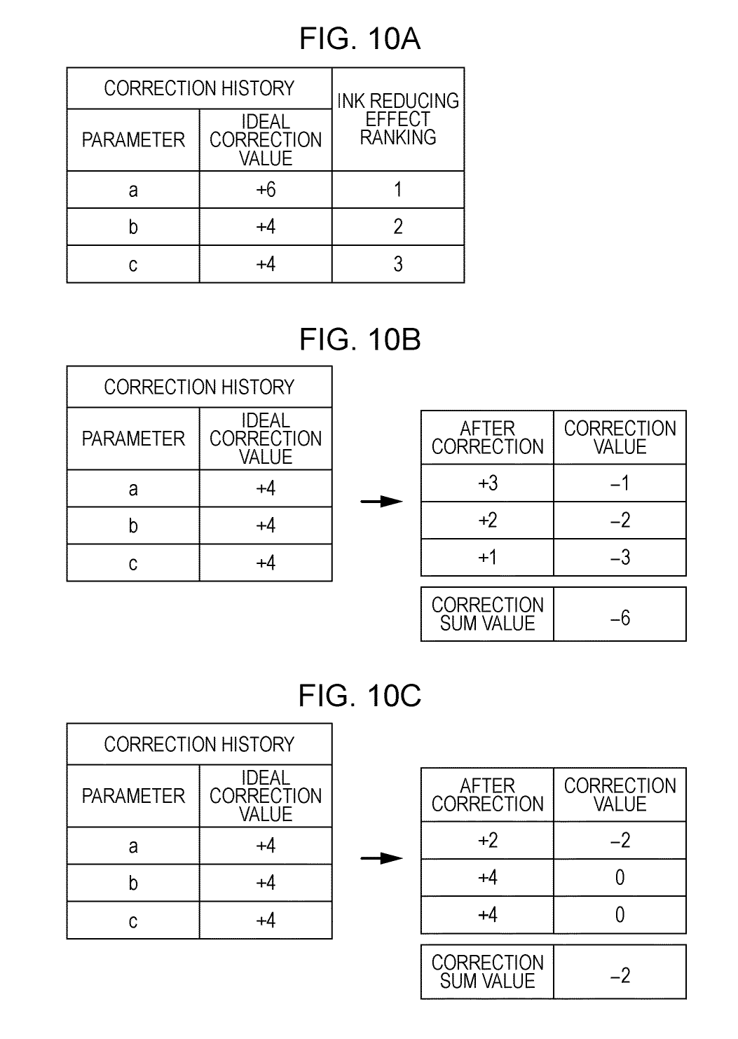

As another correction method, it is considered that a priority is set for the corrected parameters. For example, as shown in FIG. 10A, FIG. 10B, and FIG. 10C, parameters of a, b, and c are corrected from the original image by predetermined ideal correction values +4, +4, and +4 to create the ideal image. In the relation between the correction value and the ink use amount, the order of parameters easily reducing the ink use amount is a, b, and c.

When the ink reduction amounts are made uniform by the parameters, it is difficult to reduce the ink use amount in b and c as shown in FIG. 10B, the absolute value of the correction value becomes larger than a, and the image style may be drastically changed. In the correction method shown in FIG. 10C, the ink use amount is reduced to the target ink use amount by a, which most easily reduces the ink use amount. As a result, it is not necessary to correct the other parameters b and c, and suppressing the change of the image style to the minimum is expected. As described above, the relation between the organization of the parameters and the order of the correction may be regulated in advance. Of course, the priority may be set to the parameters corrected by the user. When calculating the proper correction value, it is preferable that the priority of correction is set to the parameters.

Even when ideal correction parameters and ideal correction values of a plurality of layers, which are different from each other, are included as the correction history, it is preferable to sequentially correct from a layer including high-priority ideal correction parameter.

### Correction of Tone Curve

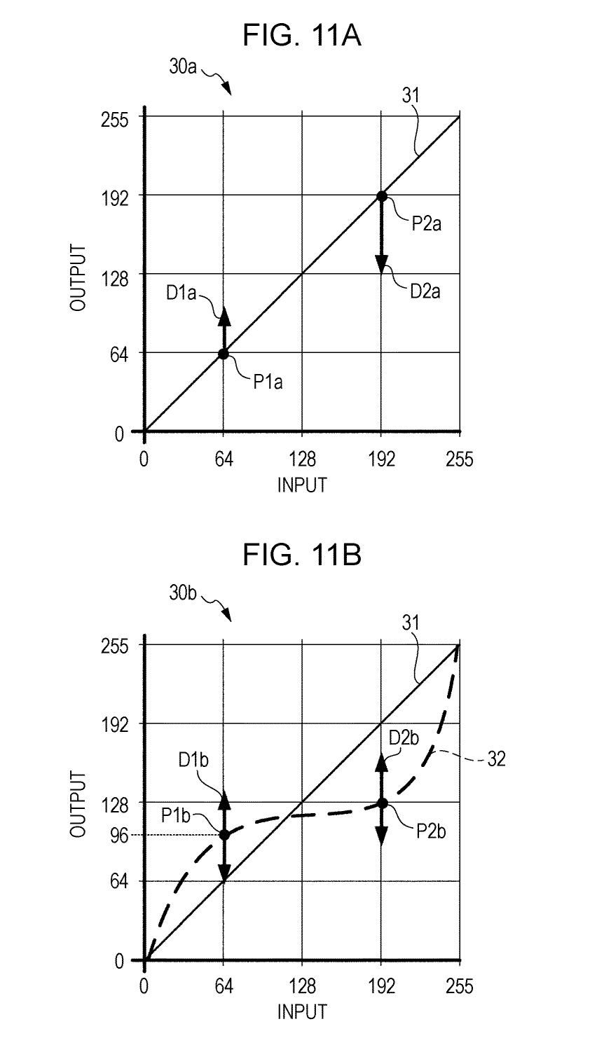

In the known tone curve as the parameters of the image process, there are many cases where the correction value is represented by the organization of an input value and an output value, not by a numerical value, unlike the other parameters. For example, as shown in FIG. 11A, the original image is represented by a straight line 31 in which relation between an input i and an output o is i=o in Graph 30a, and the correction is performed to move two points of, for example, P1a (64, 64) and P2b (192, 192) on the straight line in directions (D1a and D2a) indicated by arrows. When the ideal image is created in such a manner, the ideal correction parameter of the correction history included in the ideal image is a tone curve. When the ideal correction value is represented by a numerical value, it becomes all points on an approximate curve (tone curve) 32 passing through coordinates P1b (64, 96) and P2b (192, 128) after movement of the two points on the straight line 31 as shown in FIG. 11B. Thus, in order to correct the tone curve 32 by employing the coordinates (P1b, P2b) after movement as the ideal correction value to reduce the ink use amount, the input values (64, 192) of two movement points are increased or decreased in the directions (D1b and D2b) indicated by the arrows in FIG. 11B. Of course, the points moved from the straight line 31 of the original image are not limited to two points, and may be, for example, one point and three or more points.

### Other Embodiments

In the embodiment, the image processing software (image processing program) is installed in the computer, but a restricted-use device may be used. In addition, an image processing program stored on a recording medium or downloaded through a network is one of the embodiments of the invention. The embodiments of the invention are not limited to the use of printing the face of the coupon, and may be applied to the user of printing an image by a target ink use amount.

The invention is applicable to, for example, the use of suppressing deterioration of image quality to the minimum to print an image while reducing the ink use amount. For example, the invention is applicable to a business model in which a store or the like pays for the ink use amount to print individual coupons according to products purchased at a counter.

What is claimed is:

1. An image processing method when creating an image which a computer causes a printing apparatus forming an image to print using ink, the method comprising:
reading ideal image data including correction history information of a parameter for original image data and acquiring the parameter included in the correction history information as an ideal correction parameter;
calculating an ink use amount as an initial ink use amount when printing the ideal image data;
calculating a relation between each correction value of the ideal correction parameter and the ink use amount on the basis of the initial ink use amount;
calculating a proper correction value approximating a target ink use amount input by a user in the relation between each correction value of the ideal correction parameter and the ink use amount; and
creating correction image data in which the ideal correction parameter of the ideal image data is set by the proper correction value and displaying the correction image data on a display.

2. The image processing method according to claim 1, wherein the correction value of the ideal correction parameter is included as an ideal correction value in the correction history information,
wherein in the acquisition of the correction history, the ideal correction value included in the correction history is acquired and a direction of increase or decrease of the ideal correction parameter for the original image data is determined as an ideal direction, and
wherein in the calculation of the proper correction value, an absolute value of the proper correction value is equal to or less than an absolute value of the ideal correction value when the increase or decrease direction of the correction value upon reducing the ink use amount of the ideal image data is reverse to the ideal direction.

3. The image processing method according to claim 1, wherein the ideal image data is formed of a plurality of layer images including each correction history,
wherein in the acquisition of the correction history, the correction history included in each layer is acquired,
wherein in the calculation of the ink use amount, a relation between each correction value of the ideal correction parameter for each layer and the ink use amount is calculated, and
wherein in the calculation of the proper correction value, the proper correction value of each layer is calculated such that the ink reduction amounts of the layers are equal.

4. The image processing method according to claim 1, wherein the ideal image data is formed of a plurality of layer images including each correction history,
wherein in the acquisition of the correction history, the correction history included in each layer is acquired,
wherein in the calculation of the ink use amount, a relation between each correction value of the ideal correction parameter for each layer and the ink use amount is calculated, and
wherein in the calculation of the proper correction value, the proper correction value of each layer is calculated such that an ink reduction amount of the layer designated by an input of the user reaches the maximum.

5. The image processing method according to claim 1, wherein the correction history includes an ideal correction value for each of a plurality of ideal correction parameters,
wherein in the calculation of the ink use amount, a relation between each correction value for each of the plurality of ideal correction parameters and the ink use amount is calculated, and
wherein in the calculation of the proper correction value, the proper correction value for each ideal correction parameter is calculated such that the ink reduction amounts of the ideal correction parameters are equal.

6. The image processing method according to claim 1, wherein the correction history includes an ideal correction value for each of a plurality of ideal correction parameters,
wherein in the calculation of the ink use amount, a relation between each correction value for each of the plurality of ideal correction parameters and the ink use amount is calculated, and
wherein in the calculation of the proper correction value, the proper correction value for each ideal correction parameter is calculated such that the ink reduction amount reaches the maximum in order from a high-priority ideal correction parameter according to correction priority set for each parameter.

7. An image processing apparatus creating an image printed by a printing apparatus forming an image using ink, comprising:
a correction history acquiring unit reading ideal image data including correction history information of a parameter for original image data and acquiring the parameter included in the correction history information as an ideal correction parameter;
an ideal image ink use amount calculating unit calculating an ink use amount when printing the ideal image data as an initial ink use amount;
an ink use amount calculating unit calculating a relation between each correction value of the ideal correction parameter and the ink use amount on the basis of the initial ink use amount;
a proper correction value calculating unit calculating a proper correction value approximating a target ink use amount input by a user in the relation between each correction value of the ideal correction parameter and the ink use amount; and
a correction image displaying unit creating correction image data in which the ideal correction parameter of the ideal image data is set by the proper correction value and displaying the correction image data on a display.
